(19) United States
(12) Patent Application Publication
(10) Pub. No.: US 2009/0015506 A1
(43) Pub. Date: Jan. 15, 2009

(54) PLANAR ANTENNA

(75) Inventor: YEN-YI SHIH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/036,302

(22) Filed: Feb. 25, 2008

(30) Foreign Application Priority Data
Jul. 12, 2007 (CN) 200710201056.3

(51) Int. Cl. H01Q 1/50; H01Q 1/38

(52) U.S. Cl. 343/860; 343/700 MS

(57) ABSTRACT

A planar antenna (10) is disposed on a substrate (20). The planar antenna includes a grounding portion (12), a radiating body (16), a feeding portion (14), and a matching portion (18). The grounding portion is disposed on one surface of the substrate. The radiating body includes a first radiating portion (161), a second radiating portion (162), a third radiating portion (163), a fourth radiating portion (164), and a fifth radiating portion (165), which are perpendicularly connected one by one and extend according to a generally clockwise pattern. The feeding portion configured neighboring the grounding portion is electronically connected to the radiating body, for feeding electromagnetic signals to the radiating body. The matching portion is electronically connected to the grounding portion, as well as to the radiating body and the feeding portion.

### BACKGROUND

1. Field of the Invention

The present invention relates to a planar antenna.

2. Description of Related Art

Recently, there has been a significant growth in WLAN (wireless local area network) technology due to the ever growing demand for wireless communication products. Such growth becomes particularly prominent after the promulgation of IEEE 802.11 WLAN protocol in 1997. The IEEE 802.11 WLAN protocol not only offers many novel features to the current wireless communication technologies, but also provides a solution for enabling two wireless communication products manufactured by different companies to communicate with each other.

Antennas are necessary components in the wireless communication devices for radiating electromagnetic signals. In order to obtain a small size of the wireless communication device, the antennas associated therewith are correspondingly required to have a reduced size, as well as meet higher performance standards.

### SUMMARY OF THE INVENTION

One aspect of the present invention provides a planar antenna. The planar antenna is disposed on a substrate for radiating electromagnetic signals. The planar antenna includes a grounding portion, a radiating body, a feeding portion, and a matching portion. The grounding portion is disposed on one surface of the substrate. The radiating body includes a first radiating portion, a second radiating portion, a third radiating portion, a fourth radiating portion, and a fifth radiating portion, which are perpendicularly connected one by one and extended according to a generally clockwise pattern. The feeding portion is configured neighboring the grounding portion and electronically connected to the radiating body, for feeding electromagnetic signals to the radiating body. The matching portion is electronically connected to the grounding portion, as well as to the radiating body and the feeding portion.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a planar antenna in accordance with an embodiment of the invention;

FIG. 2 is a schematic diagram of a planar antenna in accordance with another embodiment of the invention;

FIG. 3 is a schematic diagram illustrating dimensions of the planar antenna of FIG. 1;

FIG. 4 illustrates return loss of the planar antenna of FIG. 1;

FIG. 5 is a graph of test results showing a X-Y planar horizontal polarization radiation pattern of the planar antenna of FIG. 1;

FIG. 6 is a graph of test results showing a Y-Z planar horizontal polarization radiation pattern of the planar antenna of FIG. 1; and

FIG. 7 is a graph of test results showing a X-Z planar horizontal polarization radiation pattern of the planar antenna of FIG. 1.

### DETAILED DESCRIPTION OF THE INVENTION

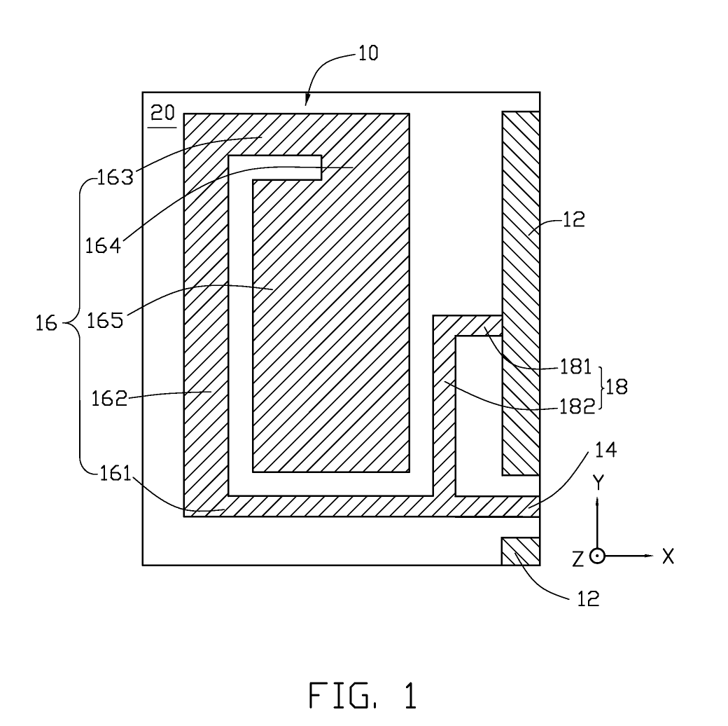

FIG. 1 is a schematic diagram of a planar antenna 10 in accordance with an embodiment of the invention.

In this embodiment, the planar antenna 10 is disposed on a substrate 20 for radiating electromagnetic signals. The planar antenna 10 includes a grounding portion 12, a feeding portion 14, a radiating body 16, and a matching portion 18. The grounding portion 12 is laid on one surface of the substrate 20. The feeding portion 14 is electronically connected to the radiating body 16 for feeding electromagnetic signals to the radiating body 16. The resistance value of the feeding portion 14 is about 50 ohms. The matching portion 18 is electronically connected to the grounding portion 12, as well as to the radiating body 16 and the feeding portion 14.

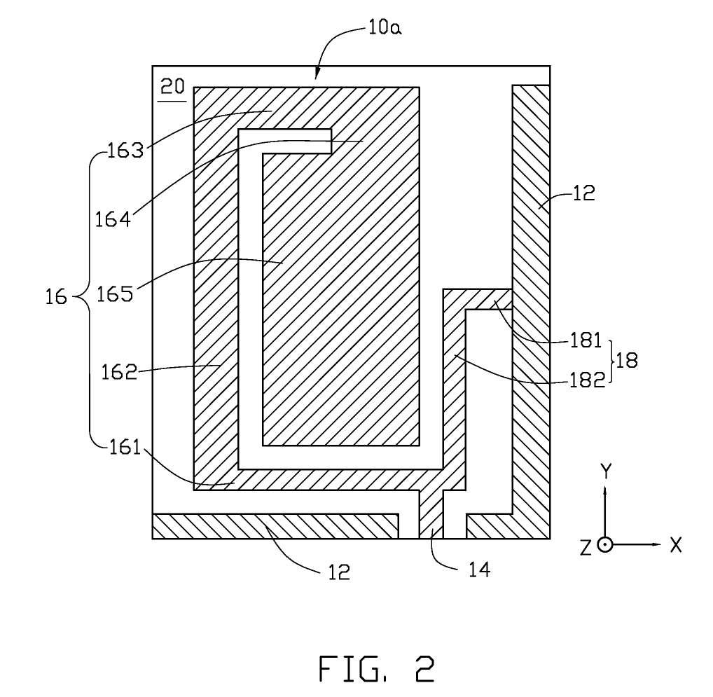

The radiating body 16 includes a first radiating portion 161, a second radiating portion 162, a third radiating portion 163, a fourth radiating portion 164, and a fifth radiating portion 165. The first radiating portion 161 is electronically connected to the feeding portion 14. In practical application, the feeding portion 14 can be aligned with the first radiating portion 161 as shown in FIG. 1, the feeding portion 14 can also be perpendicularly connected to the first radiating portion 161 as shown in FIG. 2. The first radiating portion 161, the second radiating portion 162, the third radiating portion 163, the fourth radiating portion 164, and the fifth radiating portion 165 are arranged in that sequence, with each subsequent radiating section 162, 163, 164, 165 extending perpendicularly from the preceding radiating section 161, 162, 163, 164. In the illustrated embodiment, each of the radiating sections 161˜165 is straight. Each subsequent radiating section 162, 163, 164, 165 extends perpendicularly according to a generally clockwise pattern, such that the five radiating sections 161˜165 form a quasi-spiral shape. The second radiating portion 162 is parallel to the fifth radiating portion 165.

The first radiating portion 161, the second radiating portion 162, and the third radiating portion 163 surround the fourth radiating portion 164 and the fifth radiating portion 165. The width of the fifth radiating portion 165 is greater than the widths of the first radiating portion 161, the second radiating portion 162, the third radiating portion 163, and the fourth radiating portion 164. The fifth radiating portion 165 can extend the working frequency band of the planar antenna 10.

The matching portion 18 is bent, and includes a first matching section 181 and a second matching section 182 perpendicularly and electronically connected to the first matching section 181. The second matching section 182 is electronically connected to the feeding portion 14, and parallel to the second radiating portion 162. In this embodiment, the matching portion 18 can eliminate the inductance effect produced by the radiating body 16 and the grounding portion 12.

FIG. 2 is a schematic diagram of a planar antenna 10a in accordance with another embodiment of the invention. The planar antenna 10a of this embodiment is similar to the planar antenna 10 of FIG. 1, the difference therebetween is that the feeding portion 14 is aligned with the first radiating portion 161 in FIG. 1 and the feeding portion 14 is perpendicularly connected to the first radiating portion 161 in FIG. 2. Other components assigned the same reference numerals as in FIG. 1 are the same as those in FIG. 1, and descriptions thereof are omitted.

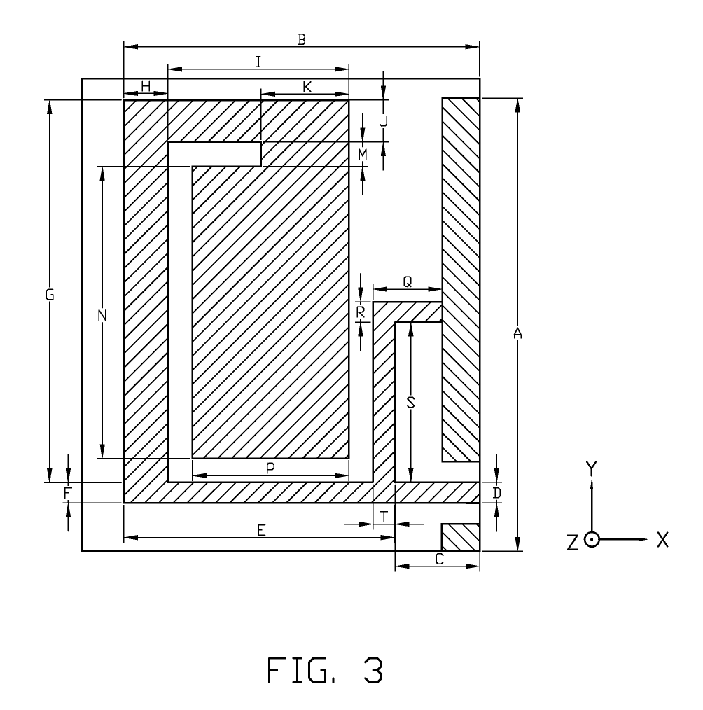

FIG. 3 is a schematic diagram illustrating dimensions of the planar antenna 10 of FIG. 1.

As shown in FIG. 3, the total length A of the planar antenna 10 is about 10 millimeters (mm), and the total width B thereof is about 8 mm. The length C of the feeding portion 14 is about 2 mm, and the width D thereof is about 0.5 mm. The length E of the first radiating portion 161 is about 6 mm, and the width F thereof is about 0.5 mm. The length G of the second radiating portion 162 is about 8.5 mm, and the width H thereof is about 1 mm. The length I of the third radiating portion 163 is about 4 mm, and the width J thereof is about 1 mm. The length K of the fourth radiating portion 164 is about 2 mm, and the width M thereof is about 0.5 mm. The length N of the fifth radiating portion 165 is about 6.5 mm, and the width P thereof is about 3.5 mm. The length Q of the first matching section 181 is about 1.5 mm, and the width R thereof is about 0.5 mm. The length S of the second matching section 182 is about 3.5 mm, and the width T thereof is about 0.5 mm.

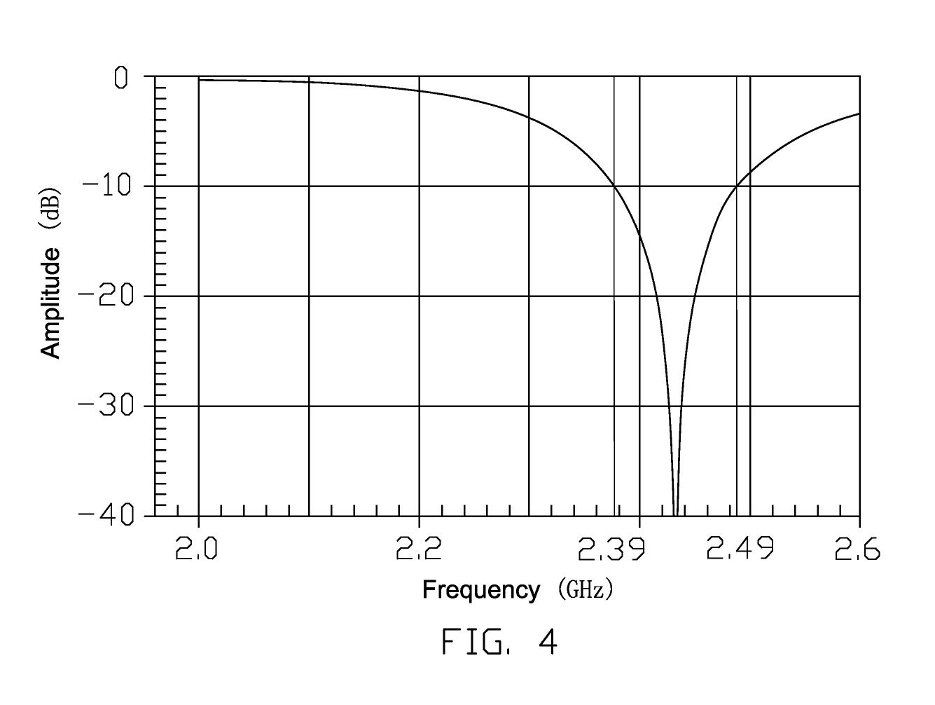

FIG. 4 illustrates return loss of the planar antenna 10 of FIG. 1. As shown in FIG. 4, the planar antenna 10 performs well when operating at frequencies of 2.39-2.49 GHz. The amplitudes of the return loss in the band pass frequency range are smaller than a value of −10, indicating that the planar antenna 10 complies with known standards of operation of IEEE 802.11 WLAN devices.

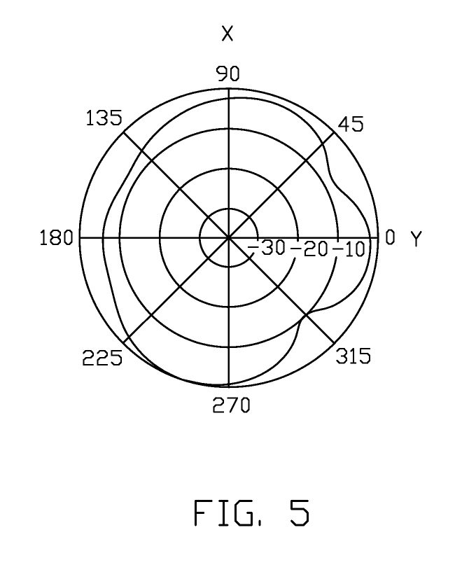

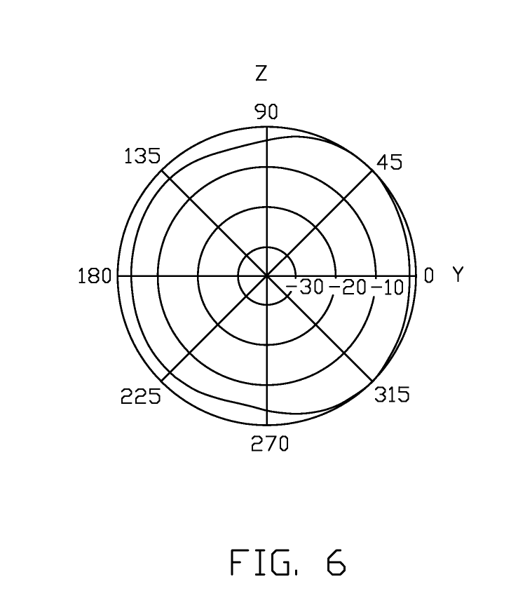

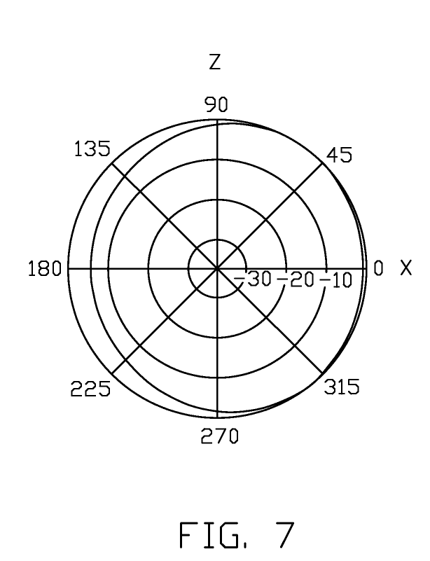

FIGS. 5-7 show horizontal polarization radiation pattern when the planar antenna 10 respectively operates at a X-Y plane, a Y-Z plane, and a X-Z plane. As shown, all of the radiation patterns are substantially omni-directional.

The planar antenna 10 (10a) not only operates at a frequency of 2.4 GHz. When the size and/or shape of the radiating body 16 is changed or configured appropriately, the planar antenna 10 can function according to other various desired communication standards or ranges.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A planar antenna, disposed on a substrate for radiating electromagnetic signals, the planar antenna comprising:
a grounding portion disposed on one surface of the substrate;
a radiating body comprising a first radiating portion, a second radiating portion, a third radiating portion, a fourth radiating portion, and a fifth radiating portion, which are perpendicularly connected one by one and extending according to a generally clockwise pattern;
a feeding portion configured neighboring the grounding portion and electronically connected to the radiating body, for feeding electromagnetic signals to the radiating body; and
a matching portion electronically connected to the grounding portion, as well as to the radiating body and the feeding portion.

2. The planar antenna as recited in claim 1, wherein the first radiating portion, the second radiating portion, and the third radiating portion surround the fourth radiating portion and the fifth radiating portion.

3. The planar antenna as recited in claim 2, wherein a width of the fifth radiating portion is greater than the widths of the first radiating portion, the second radiating portion, the third radiating portion, and the fourth radiating portion.

4. The planar antenna as recited in claim 1, wherein the resistance value of the feeding portion is about 50 ohms.

5. The planar antenna as recited in claim 1, wherein the matching portion is electronically connected to the first radiating portion.

6. The planar antenna as recited in claim 5, wherein the matching portion comprises a first matching section and a second matching section perpendicularly and electronically connected to the first matching section.

7. The planar antenna as recited in claim 6, wherein the first matching section is perpendicularly and electronically connected to the grounding portion.

8. A planar antenna, comprising:
a radiating body, composed by a plurality of radiating portions, the radiating portions being perpendicularly connected one by one and consequently formed a quasi-spiral shape, the radiating body comprising an open end disposed in the center of the quasi-spiral shape and a short end;
a feeding portion, electronically connected to the short end of the radiating body;
a grounding portion; and
a matching portion, electronically connected to the short end, as well as the feeding portion and the grounding portion.

9. The planar antenna as recited in claim 8, wherein the matching portion and the radiating body co-form another quasi-spiral shape.

10. An antenna assembly comprising:
a substrate; and
an antenna formed on a surface of said substrate, said antenna comprising a radiating body for radiating electromagnetic signals, a feeding portion electrically connected to said radiating body for feeding electromagnetic signals to said radiating body, a grounding portion disposed on said surface of said substrate neighboring said radiating body for being grounded, and a matching portion electrically connected between said radiating body, said feeding portion and said grounding portion, said radiating body comprising a radiating portion defined at a free end of said radiating body and another radiating portion, which has a width smaller than said radiating portion, mechanically and electrically connected between said radiating portion and said feeding portion, said radiating portion being substantially sandwiched between said another radiating portion and said matching portion.

11. The antenna assembly as recited in claim 10, wherein said radiating portion, said another radiating portion, and said matching portion extend lengthwise respectively so as to be parallel to one another.
